(19) United States
(12) Patent Application Publication
(10) Pub. No.: US 2005/0134041 A1
(43) Pub. Date: Jun. 23, 2005

(54) Structure for pipe connector, and pipe joint

(76) Inventors: Yasuhiro Kikumori, Osaka-shi (JP); Akihiro Fujii, Osaka-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/990,438

(22) Filed: Nov. 18, 2004

(30) Foreign Application Priority Data
Nov. 20, 2003 (JP) 2003-390184

(51) Int. Cl. F16L 17/00

(52) U.S. Cl. 285/319; 285/903

(57) ABSTRACT

A structure for a pipe connector, in which the insertion of a corrugated pipe end portion into a fitting cylinder is allowed by pushing and expanding the retaining members of a fitting cylinder with the ridge of the corrugated pipe end portion, and in which the corrugated pipe end portion is prevented from being drawn out from the fitting cylinder, by fitting the retaining members in the clearances between the adjoining ridges of the corrugated pipe end portion.

### BACKGROUND OF THE INVENTION

1. Field of the Invention

This invention relates to either a corrugated pipe having ridges and valleys alternately in the pipe axis direction and a pipe joint, or a structure for a pipe connector to other various pipe members and a pipe joint.

2. Description of the Related Art

In the prior art, a corrugated pipe, which is made of a synthetic resin and which has a wall formed into corrugations composed of ridges and valleys so that it is excellent in pressure- and flattening-resistance, is widely employed as a protective pipe for accommodating and protecting cables such as electric cables or optical fiber cables, or as a water supply pipe or a sewer pipe.

Of these, especially the corrugated pipe having ridges formed into a generally square shape of cross section in the pipe radial direction can be used to realize a stable pipe installation with little torsion, as disclosed in JP-A-8-219333(Japanese Patent Laid-open Number 1996-219333), for example. In case a multi-hole conduit is to be formed by bundling a plurality of pipes in parallel, moreover, the parallelity and straightity of pipes can be kept excellent.

At the piping time of this kind, the plural corrugated pipes are sequentially added by connecting them through a pipe joint, for example. The pipe joint for connecting those corrugated pipes is exemplified by a cylindrical joint body, as disclosed in JP-A-8-219333 (as referred to FIG. 4 and FIG. 5), or by a joint body constructed of a pair of semi-cylinder members, as disclosed in JP-A-2000-337573 (Japanese Patent Laid-open Number 2000-337573).

In the connection structure using the pipe joint disclosed in FIG. 4 of JP-A-8-219333, however, the corrugated pipe end portion having a packing mounted thereon is just inserted into the joint body of the pipe joint. When a strong drawing force acts on the corrugated pipe, this corrugated pipe may come out from the joint body of the pipe joint.

In the connection structure using the pipe joint disclosed in FIG. 5 of JP-A-8-219333, moreover, the corrugated pipe inserted into the joint body is prevented from being drawn out by inserting a movement preventing pin from the outside of the joint body of the pipe joint. In this case, however, an additional insertion of a pin is needed after the corrugated pipe was inserted into the joint body. This additional insertion makes the connecting work troublesome. In case the pin is inserted from the outside of the joint body, moreover, the head of the pin protrudes from the outer periphery of the pipe joint to obstruct the corrugated pipes to be bundles, thereby to raise a trouble in the formation of the aforementioned multi-hole conduit. It is also conceivable to replace the pin by an engagement member on the inner periphery side of the joint body, for example, so that the corrugated pipe may be prevented from being drawn out by bringing the engagement member into engagement with the ridge of the corrugated pipe. Merely with the engagement member being provided on the joint body, however, the outer periphery of the joint body is enlarged to expand largely outward of the ridge of the corrugated pipe or to bulge from the outer periphery of the joint body. This expansion or bulge obstructs the convergence of the corrugated pipe so that it still obstructs the aforementioned formation of the multi-hole conduit.

In the connection structure using the pipe joint disclosed in JP-A-2000-337573, moreover, the paired semi-cylinder members are arranged inside of the outer periphery of the ridge of the corrugated pipe by covering the abutting portions of the valleys of the corrugated pipe with those semi-cylinder members. This raises no trouble in the formation of the multi-hole conduit. However, the work to fasten and connect those semi-cylinder members by means of bolts is needed to complicate the connecting work.

### SUMMARY OF THE INVENTION

This invention has an object to provide a structure for a pipe connector and a pipe joint, which can prevent a corrugated pipe reliably from being drawn out. Another object is to provide a structure for a pipe connector and a pipe joint, which can simplify the connecting work. Still another object is to provide a structure for a pipe connector and a pipe joint, which can minimize the outward expansion at the portion of a structure for a pipe connector and pipe joint from the ridge so as to raise no trouble at the time of forming a multi-hole conduit.

In order to achieve the above-specified objects, according to this invention, there is provided a structure for a pipe connector, in which at least one of pipes to be connected to each other is made of a corrugated pipe having ridges and valleys alternately in the pipe axis direction and made of a synthetic resin to have the ridges shaped into a generally square section in the pipe radial direction, and in which the pipes are connected by inserting the end portion of the one corrugated pipe into the fitting cylinder having the shape of the generally square section in the other pipe of the synthetic resin. The fitting cylinder equips on its inner wall face with retaining members which are gradually lifted inwardly as they go farther from the mouth of the fitting cylinder and which are made of a thin, rigid material having inward and outward elasticities. Moreover, the insertion of the corrugated pipe end portion into the fitting cylinder is allowed by pushing and expanding the retaining members against the elastic forces thereof with the ridge of the corrugated pipe end portion. Moreover, the corrugated pipe end portion is prevented from being drawn out from the fitting cylinder by fitting the retaining members in the clearances between the adjoining ridges of the corrugated pipe end portion inserted into the fitting cylinder by their own elastic returning forces thereby to bring the leading ends of the retaining members into abutment of that one of the adjoining ridges which is located on the remoter side from the mouth.

According to this invention, there is also provided a pipe joint made of a synthetic resin for connecting the end portion of corrugated pipe made of a synthetic resin, which have ridges and valleys alternately in the pipe axis direction and in which the ridges are formed into a generally square section in the pipe radial direction. The pipe joint is provided at at least one end of its body with fitting cylinder having a generally square section, into which the corrugated pipe end portion is inserted, and the fitting cylinder equips on their inner wall face with retaining member which is gradually lifted inwardly as they go farther from the mouths of the fitting cylinder and which is made of a thin, rigid material having inward and outward elasticities. The insertion of the corrugated pipe end portion into the fitting cylinder is allowed by pushing and expanding the retaining member against the elastic forces thereof with the ridge of the corrugated pipe end portion. The corrugated pipe end portion is prevented from being drawn out from the fitting cylinder by fitting the retaining member in the clearance between the adjoining ridges of the corrugated pipe end portion inserted into the fitting cylinder by its own elastic returning force thereby to bring the leading end of the retaining member into abutment of that one of the adjoining ridges which is located on the remoter side from the mouth.

Merely by inserting the end portion of the corrugated pipe into the fitting cylinder, therefore, the retaining members equiped on the inner wall faces of the fitting cylinder can be brought into engagement with the ridge of the corrugated pipe thereby to connect the corrugated pipe and the pipe joint and so on simply while the corrugated pipe being prevented from being drawn out.

By using the retaining members made of a thin, rigid member such as a metal sheet, moreover, the strength of the retaining members can be enhanced to prevent the corrugated pipe reliably from being drawn out. By narrowing the space for providing the retaining members inward and outward in the fitting cylinder, moreover, the outward expansion of the fitting cylinder can be minimized. This can raise no trouble when the plural corrugated pipes are bundled in parallel to form the multi-hole conduit.

### BRIEF DESCRIPTION OF THE DRAWINGS

FIG. 1 is an exploded perspective view showing a structure of a pipe connecting portion using a pipe joint according to one embodiment of the invention;

FIG. 2 is a longitudinal section of the pipe joint;

FIG. 3 is a longitudinal section of the vicinity of a bayonet of the pipe joint;

FIG. 4 is a partially broken perspective view of a fitting cylinder of the pipe joint;

FIG. 5 is an exploded perspective view of the fitting cylinder;

FIG. 6 is a longitudinal section showing the state, in which a corrugated pipe is being inserted;

FIG. 7 is a longitudinal section showing the state, in which the insertion of the corrugated pipe is completed;

FIG. 8 is a longitudinal section of the corrugated pipe having a packing mounted thereon; and

FIG. 9 is a longitudinal section showing the state, in which the insertion of the corrugated pipe is also completed.

### DETAILED DESCRIPTION OF THE INVENTION

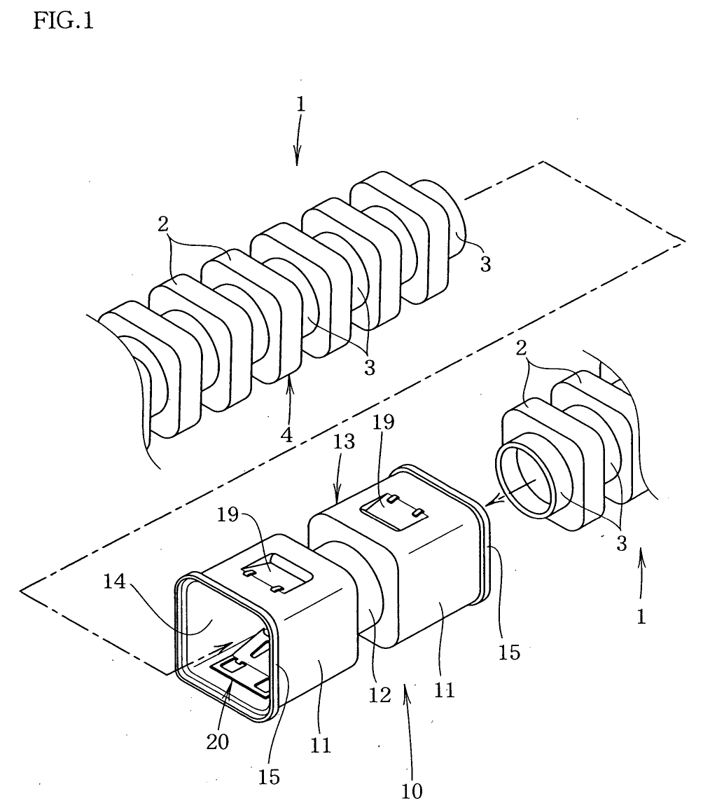

Embodiments of the invention will be described in detail with reference to the accompanying drawings. FIG. 1 explodes and shows the structure of a pipe connecting portion using a pipe joint according to one embodiment of the invention.

In FIG. 1, reference numeral (1) designates a corrugated pipe made of a synthetic resin by a blow molding method, for example. This corrugated pipe (1) is provided with a pipe wall (4) having annular ridges (2) and valleys (3) alternately in the axial direction. Of these, the ridges (2) are formed to have a generally square section in the pipe radial direction, and the valleys (3) are formed to have a generally circular section. Moreover, the pipe wall (4) can accommodate cables such as electric wire cables or optical fiber cables.

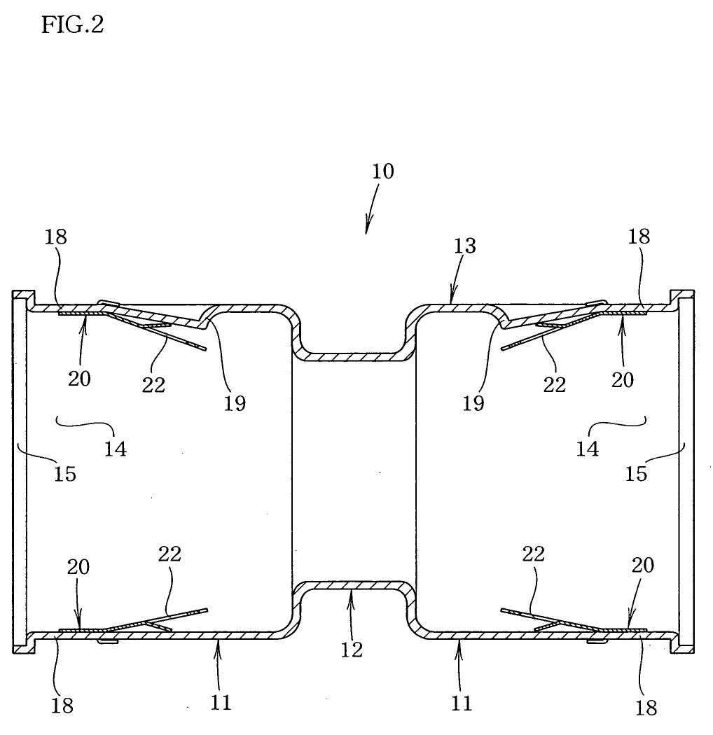

Numeral (10) designates a pipe joint made of a synthetic resin by a blow molding method, for example. This pipe joint (10) is provided, as shown in FIG. 2, with a joint body (13), composed of: a pair of fitting cylinders (11) and (11), into which the end portions of the corrugated pipes (1) and (1) are inserted; and a connector (12) connecting those fitting cylinders (11) and (11).

The fitting cylinder (11) is formed to have a generally square shape, one side of which has a slightly larger length than that of one side of the outer periphery of the ridge (2) of the corrugated pipe (1). Around the mouth (14) of the fitting cylinder (11), there is formed in an expanded state a flange (15) for holding the shape of the mouth (14) and facilitating the insertion of the end portion of the corrugated pipe (1).

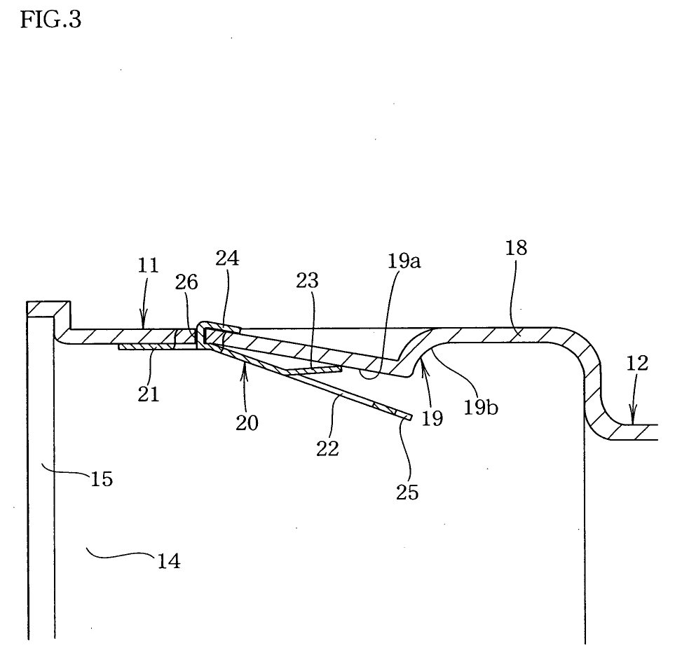

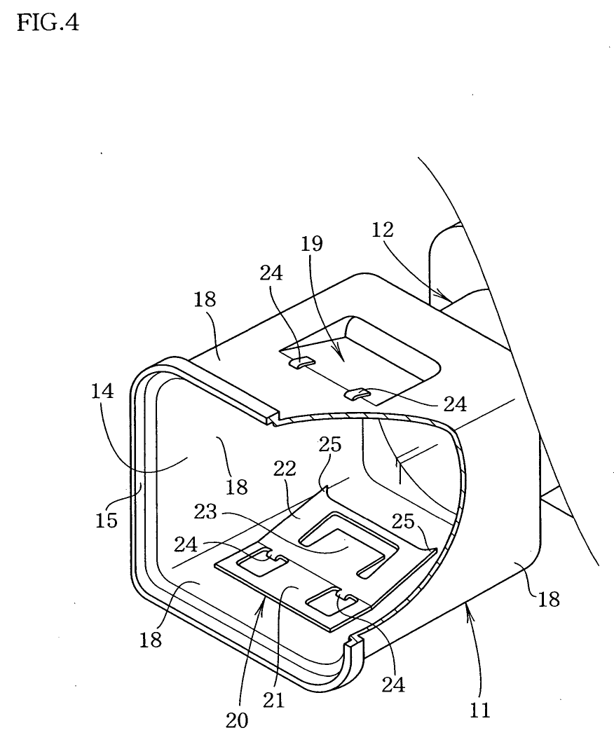

This fitting cylinder (f1) is provided with a protrusion (19) on its inner wall face by pressing in the central portion of one of four side walls (18), (18), . . . , and so on, as shown in FIG. 3 and FIG. 4. This protrusion (19) is provided with: a sloped face (19a) having a protrusion gradually increasing the more inward (toward the center axis of the fitting cylinder) as it goes the farther from the mouth (14); and a curved face (19b) shaped to accept the rounded corners of the ridges (2). This curved face (19b) is located closer to the connector (12) than the sloped face (19a). Here, the protrusion (19) should not be limited to one side wall (18) but may be disposed on the opposed side walls (18) and (18), on the orthogonal side walls (18) and (18), or on the three or four side walls (18), (18), . . . , and so on.

The fitting cylinder (11) is further provided on the inner wall face with a pair of bayonets (20) and (20) facing each other for preventing the corrugated pipe (1) inserted into the fitting cylinder (11) from coming out.

This bayonet (20) is formed by punching or bending a metal sheet as a thin, rigid member, as shown in FIG. 3 and FIG. 4. Moreover, the bayonet (20) is composed of: a base member (21) extending along the inner wall face of the fitting cylinder (11); a retaining member (22) extending from the end portion of the base member (21) on the side of the connector (12); a energizing member (23) extending from the intermediate portion of the retaining member (22); and a pair of stopper members (24) and (24) extending from the end portion of the retaining member (22) on the side of the mouth (14).

The retaining member (22) is formed into such a generally rectangular shape as has a gradually lifted inwardly face as it goes away from the mouth (14), and has inward and outward elasticities (i.e., toward and away from the center cylinder axis) so that it functions as a plate spring. Moreover, the retaining member (22) is provided with a pair of acute bite pawls (25) and (25) at the end portion thereof on the side of the connector (12), i.e., at its leading end portion. Here, these bite pawls (25) and (25) are formed individually at the two ends of the leading end portion but may also be formed either only one at the center of the leading end portion or in a saw tooth shape all over the leading end portion.

The energizing member (23) is formed into a generally rectangular shape, for example, and is arranged at the central opening portion of the retaining member (22). This energizing member (23) has a gradually increasing extension in the outward direction (i.e., away from the center cylinder axis) as its goes away from the mouth (14), to come into abutment at its leading end portion against the inner wall face of the fitting cylinder (11). At the same time, the energizing member (23) has inward and outward elasticities to function as a plate spring. In short, the energizing member (23) holds the retaining member (22) in the inward extending state in the fitting cylinder (11). Moreover, the energizing member (23) is caused, by the repulsive force resulting from the push of the inner wall face of the fitting cylinder (11) when the retaining member (22) is pushed outward, to bias energize the retaining member (22) inward thereby to assist the elastic return of the retaining member (22).

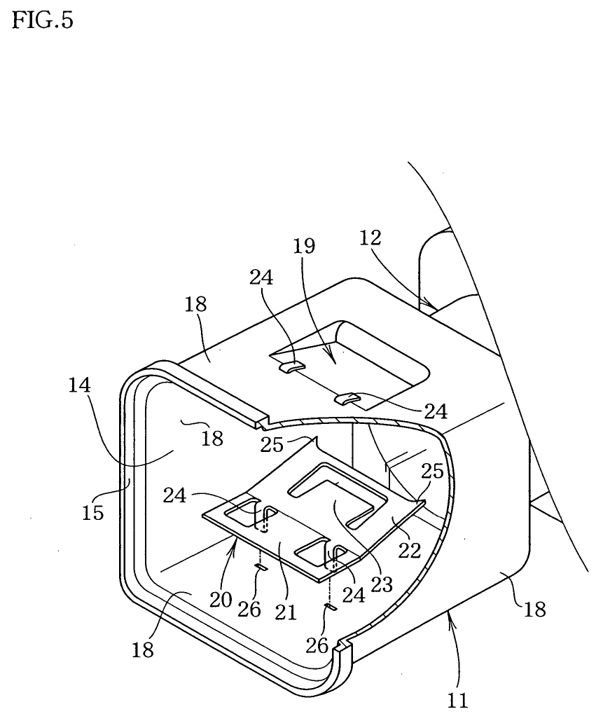

As shown in FIG. 3 and FIG. 5, the stopper members (24) are formed into a slender band shape. The stopper members (24) are extended through through holes (26) formed in the side wall (18) of the fitting cylinder (11), and are folded back along the outer wall face of the fitting cylinder (11). By these stopper members (24), the bayonet (20) is mounted on the inner wall face of the fitting cylinder (11). As a result, it is possible to simplify the mounting structure of the bayonet (20) and the mounting work.

Thus, the bayonet (20) is made of a thin metal sheet and is wholly mounted generally along the side wall (18) of the fitting cylinder (11). Therefore, the fitting cylinder (11) equipped with those bayonets (20) and (20) can narrow the space for the bayonets (20) and (20) inward and outward thereby to minimize its outer periphery.

Here, one of the paired bayonets (20) and (20) is disposed to mount its retaining member (22) on the sloped face (19a) of the protrusion (19), but their mounted positions should not be limited to that. For example, both the bayonets (20) and (20) may also be mounted on the side walls (18) and (18) having no protrusion (19). Moreover, the number of the bayonets (20) and (20) may also be one for each fitting cylinder (11) or three or more for one fitting cylinder (11), for example.

The connector (12) is formed into a generally circular section having a smaller outer circumference than that of the outer periphery of the fitting cylinder (11). Moreover, the internal diameter of the connector (12) is made so slightly larger than the external diameter of the valley (3) of the corrugated pipe (1) that the valley (3) of the corrugated pipe (1) can be inserted into the connector (12). In the pipe joint (10) thus far described, therefore, the joint body (13) is provided at its two ends with the fitting cylinders (11) and (11), which are connected by the connector (12) to enhance the strength with the constricted state of the central portion.

Here will be described the connection of the end portions of the corrugated pipes (1) and (1) using the aforementioned pipe joint (10).

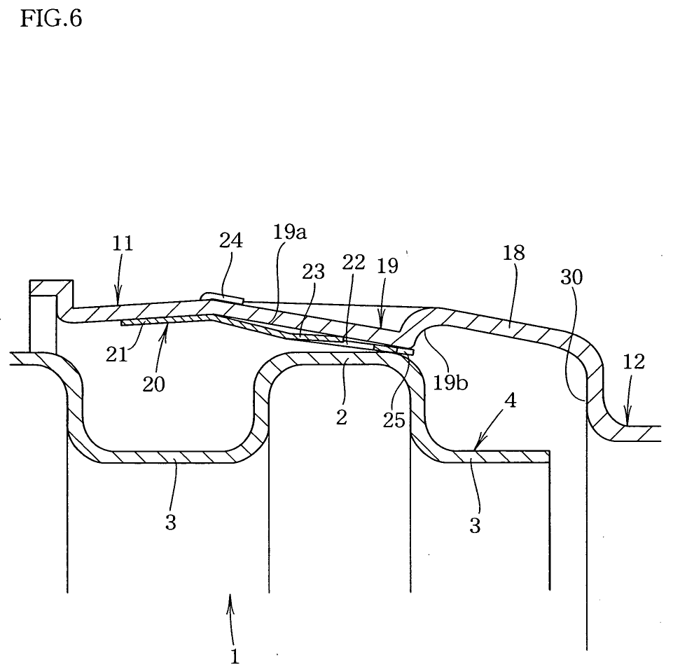

First of all, the end portion of one corrugated pipe (1) is inserted into the mouth (14) of one fitting cylinder (11) in the pipe joint (10). At this time, the ridge (2) of the corrugated pipe (1) moves while abutting against the retaining members (22) and (22) of the bayonets (20) and (20), as shown in FIG. 6. As a result, the retaining members (22) and (22) are pushed back outward against their elastic forces and the energizing forces of the energizing members (23) and (23) thereby to allow the end portion of the corrugated pipe (1) to be inserted into the fitting cylinder (11). Simultaneously with this, the ridge (2) of the corrugated pipe (1) pushes the protrusions (19) of the fitting cylinder (11) gradually outward so that the inner wall face of the fitting cylinder (11) is expanded outward.

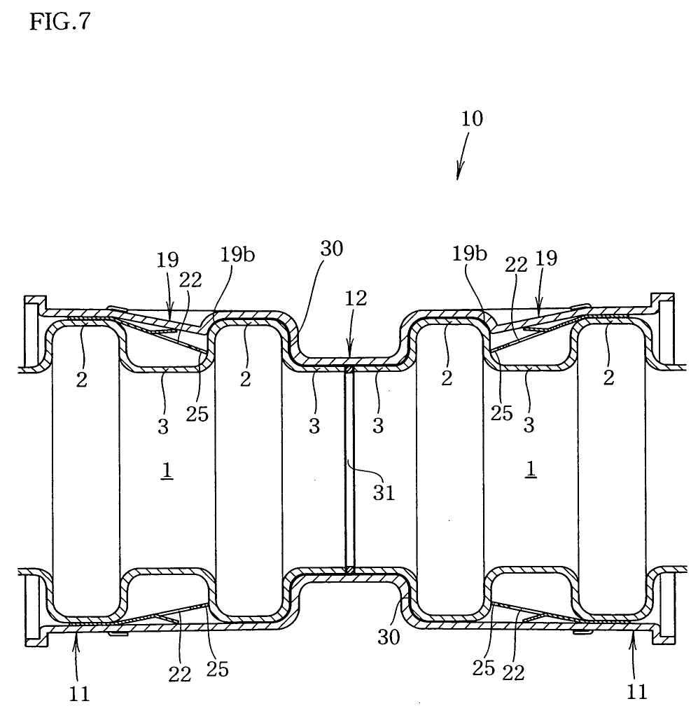

As shown in FIG. 7, moreover, the ridge (2) of the corrugated pipe (1) passes over the retaining members (22) and (22) and the protrusions (19) and comes into abutment against the stepped face (30) between the fitting cylinder (11) in the joint body (13) and the connector (12). When the leading end valley (3) of the corrugated pipe (1) is fitted in the connector (12) of the pipe joint (10), the insertion of the end portion of the corrugated pipe (1) is completed.

At this time, the retaining members (22) and (22)are elastically returned by their own elastic forces and the energizing forces of the energizing members (23) and (23). Meanwhile, the base members (21) are pushed onto the inner wall face of the fitting cylinder (11) by the ridge (2) As a result, the retaining members (22) and (22) hold the inwardly lifted state without any rattling. Then, those retaining members (22) and (22) are fitted in the clearances between the adjoining ridges (2) and (2) of the end portion of the corrugated pipe (1), and the bite pawls (25), (25), . . . , and so on at the leading end portions of the retaining members (22) and (22) bite into the remoter one (2) of the adjoining ridges (2) and (2) from the mouth (14). Specifically, the bite pawls bite into side faces of the ridge (2) extending in the pipe radial direction. As a result, the corrugated pipe (1) is reliably prevented from being drawn out from the fitting cylinder (11). Here in the corrugated pipe (1) formed by the blow molding method, the radial side faces in the ridge (2) of the pipe wall (4) may be slightly inclined with respect to the pipe radial direction. In this case, the retaining members (22) and (22) easily slip if their leading ends are just brought into abutment against the inclined side faces of the ridge (2). However, the acute bite pawls (25), (25), . . . , and so on are formed at the leading end portions of the retaining members (22) and (22) to bite into the side faces of the ridge (2). These bites can prevent the corrugated pipe (1) reliably from being drawn out, even if the side faces of the ridge (2) are inclined.

Simultaneously with these bites of the bite pawls (25), (25), . . . , and so on, moreover, the inner wall faces of the fitting cylinder (11) elastically return, and the protrusions (19) go into the clearances between the adjoining ridges (2) and (2) of the end portion of the corrugated pipe (1) such that their curved faces (19b) slide along the corners of the ridge (2) on the remoter side from the mouth (14). As a result, the corrugated pipe (1) can be firmly fixed in the fitting cylinder (11). When the protrusions (19) fit into the clearances between the adjoining ridges (2) and (2), moreover, the inner wall faces of the fitting cylinder (11) click against the outer wall faces of the corrugated pipe (1). This click is a sign that the corrugated pipe (1) has been snugly inserted to the depth thereby to complete the insertion, so that the insertion failure can be prevented.

When the insertion of one corrugated pipe (1) is thus completed by the single action, the end portion of the other corrugated pipe (1) is likewise inserted by the single action into the other fitting cylinder (11) of the pipe joint (10). As a result, the corrugated pipes (1) and (1) are connected at their end portions through the pipe joint (10). A ring-shaped packing (31) is mounted between the abutting end faces of the valleys (3) and (3) of the corrugated pipes (1) and (1).

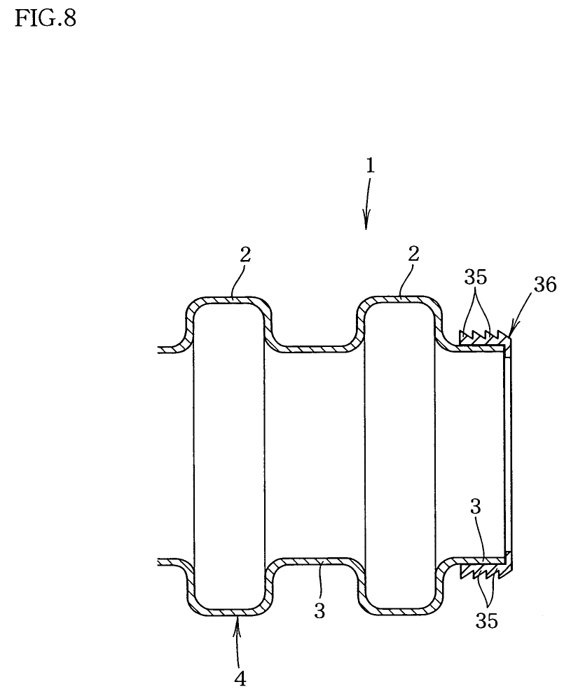

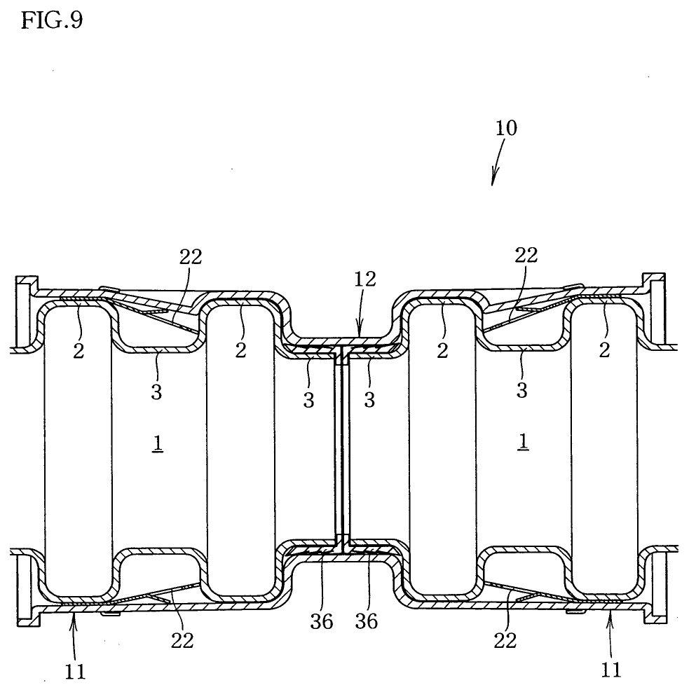

That ring-shaped packing (31) is replaced by short-cylinder packings (36) and (36), which have a plurality of annular fins (35), (35), . . . , and so on on their outer circumferences and are mounted around the leading end valleys (3) and (3) of the corrugated pipes (1) and (1), for example, as shown in FIG. 8 and FIG. 9. Moreover, the valleys (3) and (3) having the packings (36) and (36) mounted thereon are fitted in the connector (12) of the pipe joint (10), and the annular fins (35), (35), . . . , and so on of the packings (36) and (36) may be pushed onto the inner wall faces of the connector (12), thereby to stop the water.

This invention should not be limited to the embodiments thus far described but can naturally add many corrections and modifications to the embodiments within the scope of the invention. For example, the structure of the pipe connector of the invention may be applied not only to the connection between the corrugated pipe and the pipe joint but also to the connection between the corrugated pipe and a pipe member other than the pipe joint.

Moreover, the pipe joint may has the fitting member at one end portion of its joint body and the other end portion may be connect to the another type of pipe which has not the same ridges as the said corrugated pipe.

Furthermore, the corrugated pipe should not be limited to the structure, in which the ridges have the generally square section in the pipe radial direction whereas the valleys have the circular section, but may also have a structure, in which both the ridges and the valleys are formed to have a generally square section. In addition, the corrugations of the corrugated pipe should not be limited to the annular shape but may also be made helical.

1. A structure for a pipe connector, in which at least one of pipes to be connected to each other is made of a corrugated pipe having ridges and valleys alternately in the pipe axis direction and made of a synthetic resin to have said ridges shaped into a generally square section in the pipe radial direction, and in which said pipes are connected by inserting the end portion of said one corrugated pipe into the fitting cylinder having the shape of the generally square section in the other pipe of the synthetic resin,
wherein said fitting cylinder equips on its inner wall face with retaining members which are gradually lifted inwardly as they go farther from the mouth of said fitting cylinder and which are made of a thin, rigid material having inward and outward elasticities, whereby the insertion of said corrugated pipe end portion into said fitting cylinder is allowed by pushing and expanding said retaining members against the elastic forces thereof with the ridge of said corrugated pipe end portion, and whereby said corrugated pipe end portion is prevented from being drawn out from said fitting cylinder, by fitting said retaining members in the clearances between the adjoining ridges of said corrugated pipe end portion inserted into said fitting cylinder by their own elastic returning forces thereby to bring the leading ends of said retaining members into abutment of that one of said adjoining ridges which is located on the remoter side from said mouth.

2. A pipe connector structure according to claim 1,
wherein said ridges and said valleys are formed into an annular shape.

3. A pipe connector structure according to claim 1,
wherein said retaining members are made of a metal sheet.

4. A pipe connector structure according to claim 1,
wherein energizing members extending from said retaining members are brought into abutment against the inner wall faces of said fitting cylinder thereby to bias energize said retaining members expanded outward, in the inward direction.

5. A pipe connector structure according to claim 1,
wherein said retaining members are extended from base members disposed along the inner wall faces of said fitting cylinder so that the inwardly lifted state of said retaining members is held by pushing said base members onto the inner wall faces of said fitting cylinder with that ridge of said corrugated pipe end portion which is inserted into said fitting cylinder.

6. A pipe connector structure according to claim 1,
wherein acute bite pawls to bite into said ridge are formed at the leading end portions of said retaining members.

7. A pipe connector structure according to claim 1,
wherein stopper members extending from said retaining members are folded back through said fitting cylinder along the outer wall faces of said fitting cylinder thereby to mount said retaining members on the inner wall faces of said fitting cylinder.

8. A pipe connector structure according to claim 1,
wherein said fitting cylinder is provided on its inner wall faces with protrusions which are gradually expanded outward by the ridge of said corrugated pipe end portion being inserted, thereby to fit in the clearances between the adjoining ridges of said corrugated pipe end portions having completed the insertion.

9. A pipe connector structure according to claim 1,
wherein said fitting cylinder equips on its inner wall faces with a pair of retaining members opposed to each other.

10. A pipe connector structure according to claim 1,
wherein said other pipe is a pipe joint having said fitting cylinders at its two ends so that the paired corrugated pipes are connected to each other at their end portions by inserting the corrugated pipe end portions individually into the individual fitting cylinders.

11. A pipe joint made of a synthetic resin one end portion of which is connected to the end portion of corrugated pipe made of a synthetic resin, which have ridges and valleys alternately in the pipe axis direction and in which said ridges are formed into a generally square section in the pipe radial direction, and other end portion is connected to the pipe which has the same ridges as the said corrugated pipe or is connected to the another type of pipe which has not the same ridges,
wherein said pipe joint is provided at the end of its body which is connect to the said corrugated pipe with fitting cylinder having a generally square section, into which said corrugated pipe end portion is inserted,
wherein said fitting cylinder equips on their inner wall faces with retaining member which is gradually lifted inwardly as they go farther from the mouths of said fitting cylinder and which is made of a thin, rigid material having inward and outward elasticities, whereby the insertion of said corrugated pipe end portion into said fitting cylinder is allowed by pushing and expanding said retaining member against the elastic force thereof with the ridge of said corrugated pipe end portion, and whereby said corrugated pipe end portion is prevented from being drawn out from said fitting cylinder, by fitting said retaining member in the clearance between the adjoining ridges of said corrugated pipe end portions inserted into said fitting cylinder by their own elastic returning forces thereby to bring the leading end of said retaining member into abutment of that one of said adjoining ridges which is located on the remoter side from said mouth.

12. A pipe joint according to claim 11,
wherein said ridges and said valleys are formed into an annular shape.

13. A pipe joint according to claim 11,
wherein said retaining member is made of a metal sheet.

14. A pipe joint according to claim 11,
wherein said joint body is provided with a connector for connecting said fitting cylinders provided at the two ends of its body each other, and wherein said connector is formed into a generally circular shape having a smaller outer periphery than that of said fitting cylinders.

15. A pipe joint according to claim 14,
wherein the valley having the generally circular section of said corrugated pipe can be inserted into said connector.
